(19) United States
(12) Patent Application Publication
(10) Pub. No.: US 2007/0256757 A1
(43) Pub. Date: Nov. 8, 2007

(54) Safe protection device of a cutter of a wood-working shaper

(76) Inventor: Jack Yang, Taichung County (TW)

Correspondence Address: BIRCH STEWART KOLASCH & BIRCH, PO BOX 747, FALLS CHURCH, VA, 22040-0747, US

(21) Appl. No.: 11/415,178

(22) Filed: May 2, 2006

(51) Int. Cl. B27G 21/00

(52) U.S. Cl. 144/251.1

(57) ABSTRACT

A safe protection device of a cutter of a wood-working shaper has a horizontal rotatable cutter shaft installed on the top of a platform. Two sides of the cutter are respectively provided with a mounting block. The front of the rod body is pivotally provided with a pressing plate for pressing a work piece. A connecting element is assembled to tie rod body on the right side of the cutter and provided with a transparent eye shield. The eye shield includes a horizontal and a rotatable vertical eye shield plate being perpendicular thereto. The vertical eye shield plate can envelop the front location of the cutter following the work piece, thereby having the effect of safe protection during cutting. Also, the vertical eye shield plate can be drooped after cutting, whereby the worker can monitor the cutter.

### FIELD OF THE INVENTION

The present invention relates to a safe protection device of a cutter of a wood-working shaper, and more particularly to an eye shield which is a simple structure and can be simultaneously moved to envelop the cutter during inputting a work piece.

### BACKGROUND OF THE INVENTION

Referring to FIG. 1, it depicts a conventional wood-working shaper. When a wood work piece is cut by the wood-working shaper, wood flour is then ejected. A worker stands at the front of a platform 1 of the wood-working shaper, and locates at the front of a cutter. In order to protect eyes or body of the worker from the ejection of the wood flour, the platform 1 is generally provided with a goggle 2, which is located at the front thereof and perpendicular thereto. Also, when the work piece is pushed into the cutter, the worker must pay attention to the condition of cutting. Thus, generally the goggle 2 is made of the material of acrylics or polycarbonate (PC), which is the safe fireproof and flame-proof material, whereby the worker can look at the condition of cutting. However, the ejecting direction of the wood flour is uncertain, e.g. parts of the wood flour is ejected from the top of the cutter, and thus the conventional goggle 2 only covers the front of the cutter but not meet the requirement of ideal protection. Furthermore, when the wood-working shaper is shut down ordinarily, the goggle 2 is still cover the front of the cutter. Thus, the worker cannot clearly look at the cutter. Although a knife portion of the cutter is possibly damaged, it is not easy for the worker to discover the damaged knife portion. In addition, the goggle 2 must be connected to a mounting block 4 by an inserting rod 3, and the mounting block 4 is mounted on the ear 7 located on the side of a cover 6 located on the top of the platform 1 by a vertical rod 5. Thus, it is not easy for the goggle 2 to be removed upward or downward. When the work piece is not cut by the wood-working shaper, the goggle 2 is still cover the front of the cutter. For above reason, the worker cannot discover the condition of cutting or the necessity of replacement or maintenance of the cutter.

Accordingly, there exists a need for a safe protection device of a cutter of a wood-working shaper to solve the above-mentioned disadvantages.

### SUMMARY OF THE INVENTION

It is an object of the present invention to provide a safe protection device of a cutter of a wood-working shaper installed on a platform. The top of the platform is provided with a rotatable cutter shaft being perpendicular thereto. The cutter shaft is provided with a horizontally rotatable cutter. Two sides of the cutter are respectively provided with a mounting block, and a rod body respectively is laterally inserted into each mounting block. The front of the rod body is provided with a pressing plate for pressing a work piece during cutting. The present invention is characterized in that a connecting element is assembled to the rod body located in front of the cutter, and provided with a transparent eye shield. The eye shield includes a horizontal eye shield plate and a rotatable transparent vertical eye shield plate being perpendicular thereto. The vertical eye shield plate can envelop the front location of the cutter when the work piece is pushed to the cutter, thereby having the effect of protection to simultaneously envelope the cutter during cutting. Also, the worker can monitor whether the cutter is in a normal condition through the horizontal eye shield plate.

It is another object of the present invention to provide a safe protection device of a cutter of a wood-working shaper, wherein the horizontal eye shield plate can be simultaneously moved during inputting a work piece, whereby the worker can clearly look at the cutting process during cutting, and the worker can monitor whether the cutter is in an abnormal condition or damaged.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective schematic view of a conventional wood-working shaper.

FIG. 2 is a perspective schematic view of a preferred embodiment of the present invention.

FIG. 3 is an exploded perspective schematic view of an eye shield according to the preferred embodiment of the present invention.

FIG. 4A is a perspective schematic view of a preferred embodiment of the present invention showing the vertical eye shield plate which fully envelops the front of the cutter.

FIG. 4B is a perspective schematic view of a preferred embodiment of the present invention showing the vertical eye shield plate which is drooped and exposing out the cutter.

FIG. 5 is a perspective schematic view of a cutter.

FIG. 6 is a perspective schematic view of a work piece (a) after cutting.

FIG. 7 is an exploded perspective schematic view of an eye shield according to a second embodiment of the present invention.

### DETAILED DESCRIPTION OF THE PREFERRED EMBODIMENTS

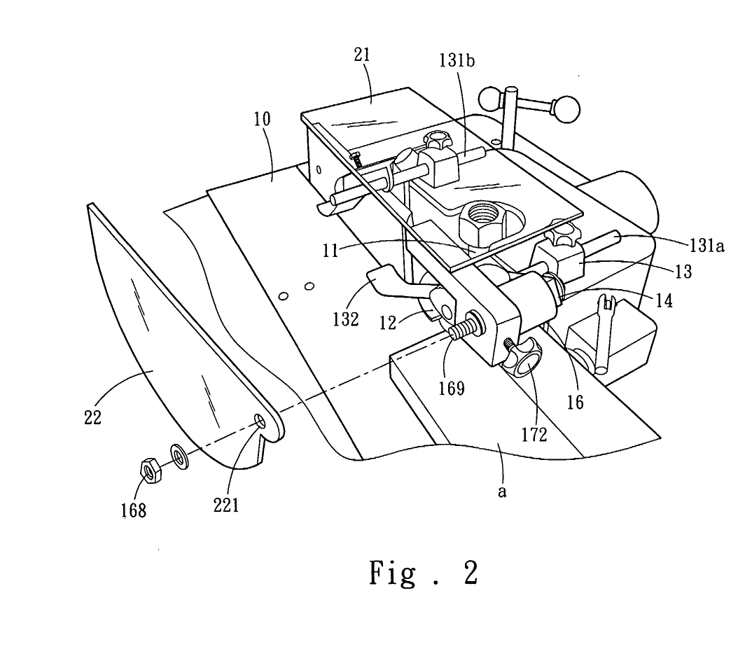

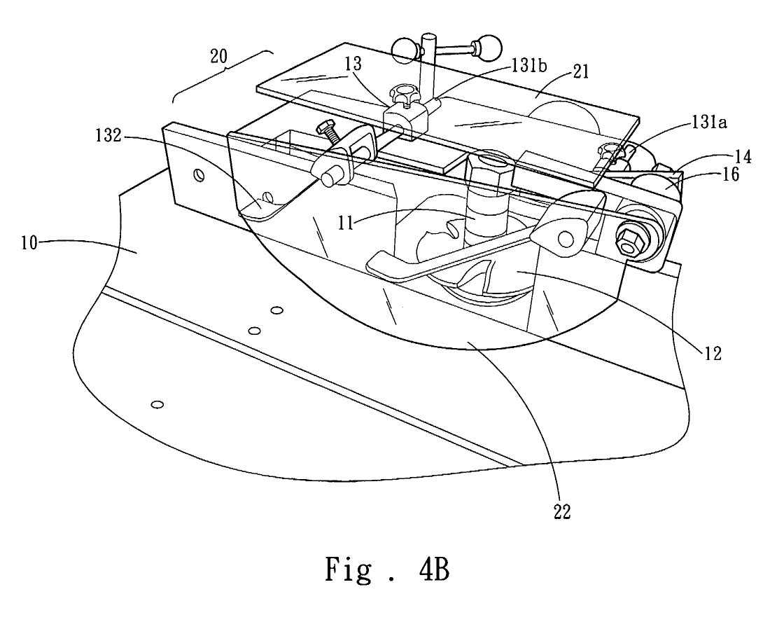

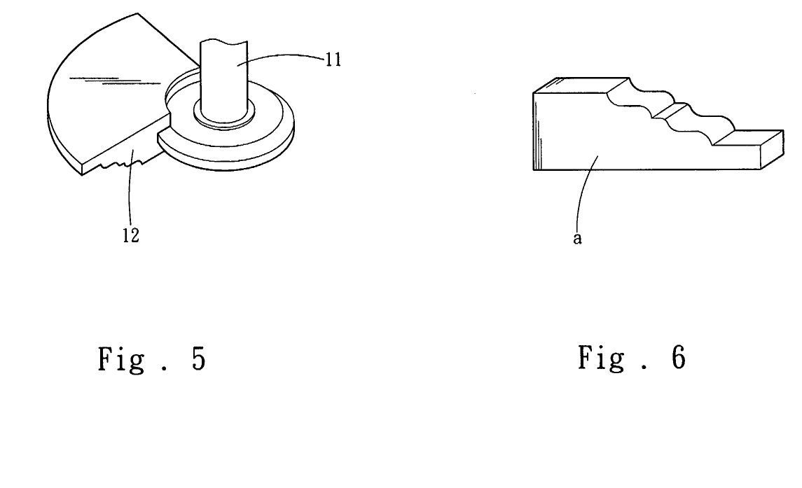

Referring to FIG. 2, it depicts a safe protection device of a cutter of a wood-working shaper according to a preferred embodiment of the present invention. The safe protection device is installed on a platform 10 of the wood-working shaper. The top of the platform 10 is provided with a rotatable cutter shaft 11 which is perpendicular thereto. A cutter 12 is vertically connected around the cutter shaft 11. The shape of cutter 12 is an arc, as shown in FIG. 5. The cutter 12 is turned by the cutter shaft 11, whereby a work piece (a) (e.g. the work piece of a wood plate) which is sideward pushed is cut, and further a shape of step is formed at one side of the plate-shaped work piece (a), as shown in FIG. 6. The top of the platform 10 is upward protruding provided with two mounting blocks 13, which each is respectively located on the left side and the right side of the cutter 12. A rod body 131a, 131b is respectively and laterally inserted into each mounting block 13 frontward and backward. A Pressing plate 132 is respectively and pivotally connected at the front of each rod body 131a, 131b, and is an arc-shaped plate which orient backward and sideward, thereby downward pressing the work piece (a).

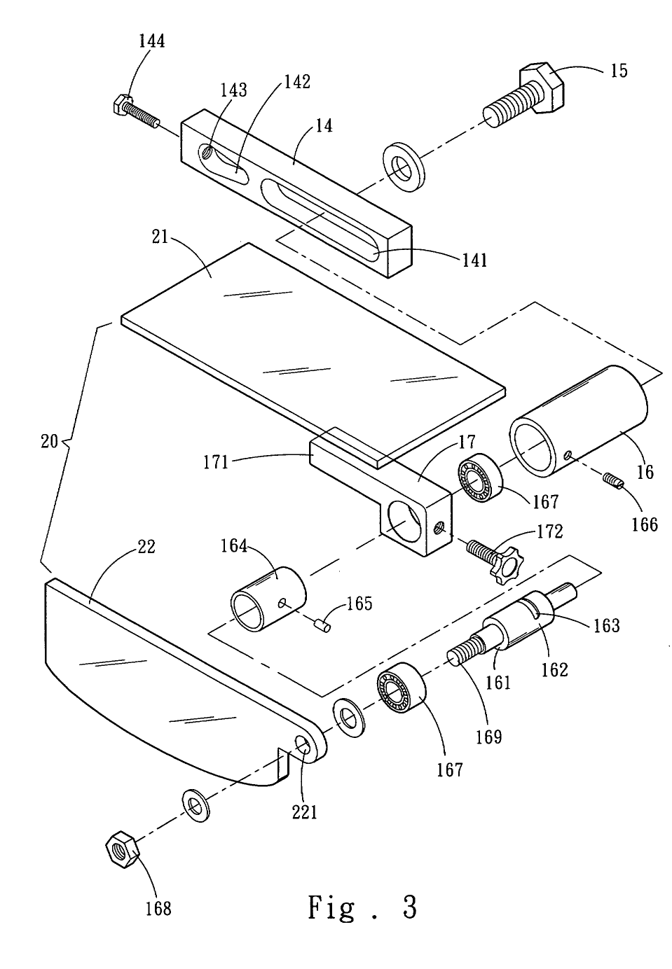

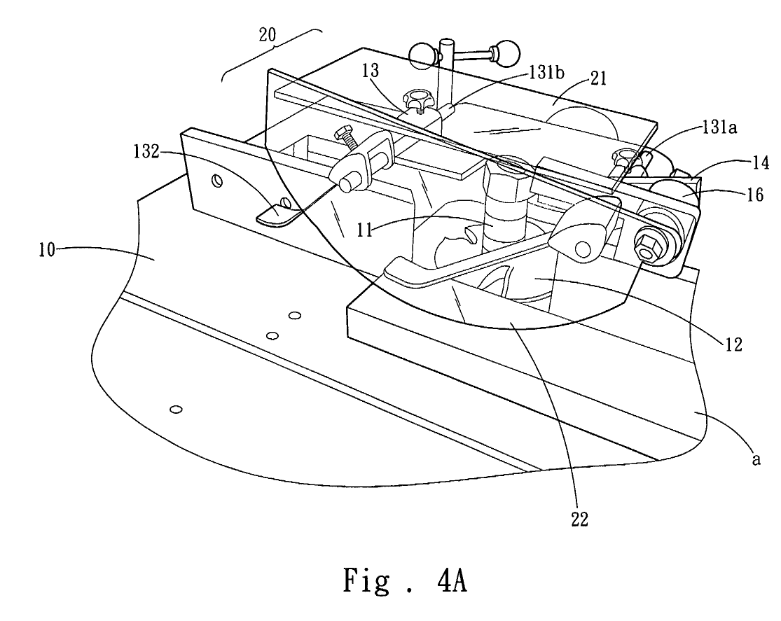

The present invention is characterized in that: A connecting element 14 is assembled to the rod body 131a located at the front and side of the cutter 12. An eye shield 20 is assembled to the connecting element 14, as shown in FIG. 3. The connecting element 14 can be a bar-shaped metal material and provided with a pivotal hole 141 and an aperture 142 which both pass therethrough. The pivotal hole 141 can be a bar-shaped hole, such that a bolt 15 can insert into the pivotal hole 141. The bolt 15 is locked into on end of a sleeve body 16, and a rod 161 is connected around the other end of the sleeve body 16. The middle of the rod 161 is provided with a middle rod 162 having larger outer diameter. The outer surface of the middle rod 162 is provided with an arc-shaped sliding groove 163. A sleeve 164 is put around the middle rod 162. A pin 165 is inserted into the outside of the sleeve 164, and then one end of the pin 165 is inserted into the sliding groove 163 of the middle rod 162. Then, the sleeve 164 is put around the sleeve body 16. A tight element 166 (e.g. a screw) is inserted into and radially locked at the outer surface of the sleeve body 16, such that one end of the tight element 166 tightly touch the outer surface of the sleeve 164. Also, bearings 167 are respectively put around the front and rear of the rod 161, wherein a sleeve element 17 is connected around the outer surface of one of the bearings 167. The sleeve element 17 is a block and mounted on the bearing 167 by sideward locking a blot 172 thereto. A supporting block 171 is extended from the top of the sleeve element 17, whereby the supporting block 171 is spraddled by and connected to a horizontal eye shield plate 21 of the eye shield 20, which is made of transparent material, e.g. acrylics. The horizontal eye shield plate 21 covers the top of the cutter shaft 11. A vertical eye shield plate 22, which is made of transparent material, e.g. acrylics, is perpendicular to the horizontal eye shield plate 21, as shown in FIG. 4A. The edge of the vertical eye shield plate 22 is provided with a hole 221, which is connected around the rod 161. Also, the vertical eye shield plate 22 is pivotally connected to the rod 161 and located at the front of the horizontal eye shield plate 21 by locking a mounting element 168 (e.g. a nut) into a thread portion 169 of the rod 161. The bottom of the vertical eye shield plate 22 is a shape of arc, and there can be a predetermined gap between the vertical eye shield plate 22 and the top surface of the platform 10 to be kept. The horizontal eye shield plate 21 and the vertical eye shield plate 22 can also be made of the material of polycarbonate (PC), which is the safe fireproof and flame-proof material.

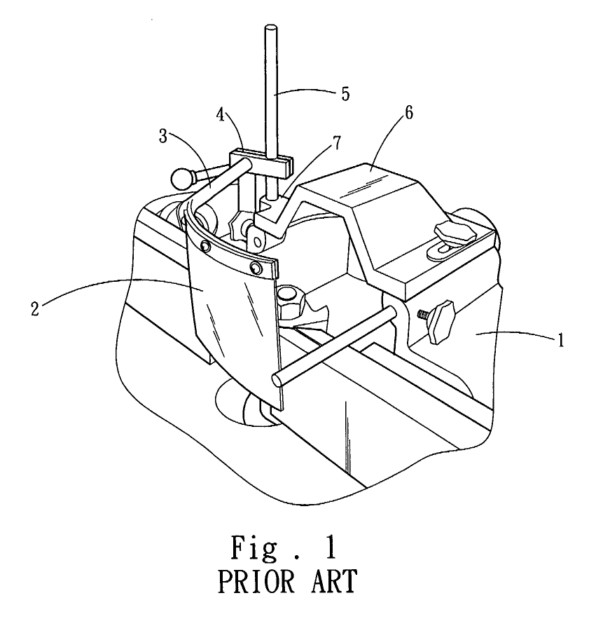

The aperture 142 located at the left side of the connecting element 14 is a shape of lateral water drop, which is gradually enlarged from right to left. The aperture 142 is put around the rod body 131a, and the left side of the connecting element 14 is provided with a screw hole 143 for locking a bolt 144 thereto, whereby the end of the bolt 144 can touch the rod body 131a for the connecting element 14 to be mounted to the rod body 131a, and the eye shield 20 can be installed on the platform 10. Compared with the prior art show in FIG. 1, the structure of the eye shield 20 of the present invention is easier, simpler and faster.

According to above-mentioned structure, the horizontal eye shield plate 21 can cover the top of the cutter shaft 11 of the platform 10 during cutting. Also, the vertical eye shield plate 22 and the horizontal eye shield plate 21 are perpendicular to each other, and the vertical eye shield plate 22 is located at the front of the cutter 12 of the platform 10, thereby enveloping the outside of the cutter 12 in two directions. When the cutter 12 is turned to cut the work piece (a), the eye shield 20 can fully isolate the worker so as to protect the eyes of the worker from the ejection of wood flour.

Particularly, the vertical eye shield plate 22 of the present invention is pivotally connected the rod 161. When the work piece (a) is pushed in the direction of the cutter 12, the work piece (a) can push and remove the vertical eye shield plate 22 to be turned clockwise, thereby fully enveloping in the front of the cutter 12, as shown in FIG. 4A. After the work piece (a) passes through the cutter 12, the vertical eye shield plate 22 is drooped naturally because of gravity, as shown in FIG. 4B, thereby exposing out the cutter 12. For above reason, the horizontal eye shield plate 21 and the vertical eye shield plate 22 can envelop the top and front location of the cutter 12 when the cutter 12 processes the cutting work, whereby the worker can safely monitor the cutting condition, and the eye shield 20 prevents the body of the worker from the ejection of the wood flour. Also, the vertical eye shield plate 22 is drooped naturally when the work piece (a) is away from the cutter 12, whereby the worker can monitor whether the cutter 12 is in a normal condition.

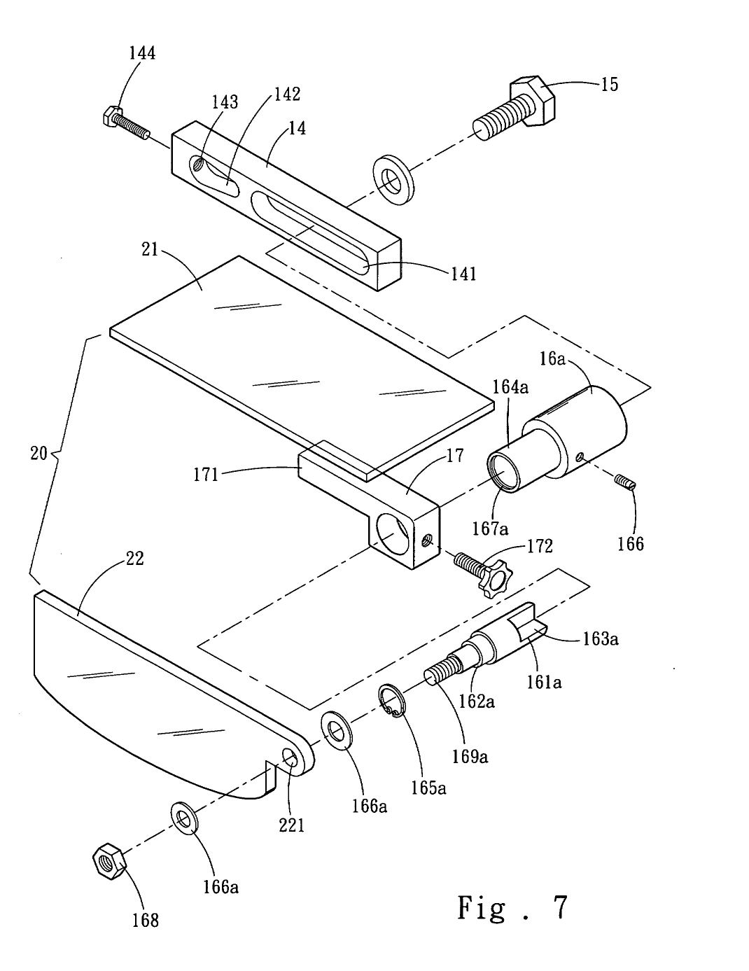

Referring to FIG. 7, it depicts a safe protection device of a cutter of a wood-working shaper according to a second embodiment of the present invention. The safe protection device of the cutter of the wood-working shaper in the second embodiment is substantially similar to that in the preferred embodiment, the sleeve body 16 could be the sleeve body 16a with a sleeve 164a located at the front thereof, wherein the outer diameter of the sleeve 164a is smaller than that of the sleeve body 16a. The hollow interior of the sleeve body 16a can be put around a rod 161a. The rod 161a is provided with a grooved indentation 163a located at one end thereof, and the other end of the rod 161a is provided with a middle rod 162a, whose the outer diameter is smaller than that of the sleeve 161a. A C-shaped ring 165a can be put around the middle rod 162a, and then a spacer 166a is put around the middle rod 162a. The outer edge of the C-shaped ring 165a is engaged into an annular groove 167a located on the inner surface of the sleeve 164a to prevent the rod 161a from dropping out. A sleeve element 17 is put around the sleeve 164a and mounted by locking a blot 172 thereinto so as to tightly touch the outer surface of the sleeve 164a. The hole 221 of the vertical eye shield plate 22 is put around the middle rod 162a of the rod 161a, the front of the rod 161a is provided with a thread portion 169a, another spacer 166a is put around the thread portion 169a, and then a mounting element 168 is locked at the thread portion 169. Also, a tight element 166 is inserted into and locked at the outer surface of the sleeve body 16a, such that one end of the tight element 166 is positioned in the grooved indentation 163a of the rod 161a so as to limit the range of angle of the rod 161a to be turned. Thus, the vertical eye shield plate 22 is also turned without two bearings 167 in the preferred embodiment.

In conclusion, the safe protection device of the cutter of the wood-working shaper according to the specification and figures of the present invention has been manufactured to an actual sample. The actual sample has been tested repeatedly and can prove the expectable objective and effect of the present invention, thereby solving the disadvantages of the goggles 2 of the conventional wood-working shaper, as shown in FIG. 1.

Although the invention has been explained in relation to its preferred embodiment, it is not used to restrain the invention. It is to be understood that many other possible modifications and variations can be made by those skilled in the art without departing from the spirit and scope of the invention as hereinafter claimed.

1. A safe protection device of a cutter of a wood-working shaper, installed on a platform of said wood-working shaper, a top of said platform provided with a rotatable cutter shaft being perpendicular thereto, said cutter shaft provided with a horizontally rotatable cutter, a work piece is sideward pushed into said cutter, said safe protection device comprising:
a connecting element assembled on said platform; and an eye shield assembled to said connecting element, wherein said eye shield comprises a transparent horizontal eye shield plate for covering a top of said cutter shaft, and a transparent vertical eye shield plate located in front of said cutter and pivotally connected to said connecting element, the vertical eye shield plate pivoting by gravity to a home position after a work piece is removed.

2. The safe protection device of a cutter of a wood-working shaper according to claim 1, wherein mounting blocks are provided on two sides of said cutter, the mounting blocks being on said platform and a rod body being laterally inserted into each mounting block, a pressing plate being pivotally connected at a front of each rod body, and said connecting element assembled to said rod body being, located in front of said cutter.

3. The safe protection device of a cutter of a wood-working shaper according to claim 2, wherein said connecting element is a bar-shaped metal material, said connecting element is provided with a pivotal hole and an aperture which both pass therethrough, a bolt in said pivotal hole locks into on end of a sleeve body, a rod is connected around an other end of said sleeve body, the middle of said rod is provided with a middle rod having a larger outer diameter than a remainder of the rod, a sleeve surrounds said middle rod such that said middle rod is rotatable, a sleeve element located under said horizontal eye shield plate surrounds the front of said middle rod, a top edge of said vertical eye shield plate is provided with a bole which is connected around said rod and locked by a mounting element, said aperture surrounds said rod body located at a front and side of said cutter, and the left side of said connecting element is provided with a screw hole for locking a bolt thereto, an end of said connecting element touches said rod body.

4. The safe protection device of a cutter of a wood-working shaper according to claim 3, wherein bearings are around the front and rear of said rod, said sleeve element located under said horizontal eye shield plate is connected around the ouster surface of one of said bearings, and a supporting block is extended from the top of said sleeve element, said supporting block is connected to said horizontal eye shield plate.

5. The safe protection device of a cutter of a wood-working shaper according to claim 3, wherein said pivotal hole.

6. The safe protection device of a cutter of a wood-working shaper according to claim 3, wherein an outer surface of said middle rod is provided with an arc-shaped sliding groove, a pin in said sleeve touches said sliding groove of said middle rod.

7. The safe protection device of a cutter of a wood-working shaper according to claim 3, wherein said sleeve element is mounted on said beaming by sideward locking a bolt into said sleeve element.

8. The safe protection device of a cutter of a wood-working shaper according to claim 3, wherein an element is inserted into and radially locked at an outer surface of said sleeve body, such that one end of said element touches the outer surface of said sleeve.

9. The safe protection device of a cutter of a wood-working shaper according to claim 8, wherein said element is a screw.

10. The safe protection device of a cutter of a wood-working shaper according to claim 1, wherein a bottom of said vertical eye shield plate is arc-shaped, a a predetermined gap is provided between said vertical eye shield plate and the top surface of said platform.

11. The safe protection device of a cutter of a wood-working shaper according to claim 1, wherein said horizontal eye shield plate and said vertical eye shield plate is selected from one of the material of acrylics or polycarbonate.

12. The safe protection device of a cutter of a wood-working shaper according to claim 3, wherein said sleeve body has a sleeve located at a front thereof; a sleeve element surrounds said sleeve and is locked by bolt, a hollow interior of said sleeve body surrounds another rod, said rod is provided with a grooved indentation located at one end thereof, said grooved indentation is used for inserting an end of an element thereinto, the other end of said rod is provided with a middle rod with an outer diameter smaller than that of said sleeve, a C-shaped ring surrounds said middle rod, an outer edge of said C-shaped ring engages an annular groove located on the inner surface of said sleeve, the front of said rod is provided with a thread portion, and said hole of said vertical eye shield plate surrounds said thread portion and is locked by said mounting element.

13. The safe protection device of a cutter of a wood-working shaper according to claim 12, wherein said element is a screw, the front and rear of said hole of said vertical eye shield plate is respectively provided with a spacer connected around said thread portion.

14. The safe protection device of a cutter of a wood-working shaper according to claim 12, wherein said horizontal eye shield plate and said vertical eye shield plate is selected from one of the material of acrylics or polycarbonate.
